(19) United States
(12) Patent Application Publication
(10) Pub. No.: US 2014/0217625 A1
(43) Pub. Date: Aug. 7, 2014

(54) METHOD OF IMPRESSION-BASED PRODUCTION OF A FILTER FOR AN ELECTROMAGNETIC RADIATION

(71) Applicants: Jérôme Hazart, Eybens (FR); Stefan Landis, Voiron (FR)

(72) Inventors: Jérôme Hazart, Eybens (FR); Stefan Landis, Voiron (FR)

(73) Assignee: COMMISSARIAT A L'ENERGIE ATOMIQUE ET AUX ENERGIES ALTERNATIVES, Paris (FR)

(21) Appl. No.: 14/130,751

(22) PCT Filed: Jul. 4, 2012
(86) PCT No.: PCT/IB2012/053415

§ 371 Date: Mar. 26, 2014

(30) Foreign Application Priority Data
Jul. 8, 2011 (FR) 1156233

(51) Int. Cl. G02B 5/23

(52) U.S. Cl. CPC G02B 5/23
USPC 264/1.7

(57) ABSTRACT

A process for producing an electromagnetic radiation filter includes at least two color filters, each formed from a stack on a stiff substrate of at least one dielectric layer and of metal layers in alternation, in order to transmit at least two colors. The process comprises depositing on said substrate a first metal layer, depositing on said first metal layer a first mechanically deformable dielectric layer having a set thickness e₀, depositing on said first dielectric layer a second metal layer, imprinting the stack obtained with a mold applied to the entire surface of the stack and allowing material to be simultaneously moved in at least two zones of the stack, wherein in said at least two zones, two different thicknesses e₁, e₂ of said first dielectric layer are obtained, these two thicknesses being different from the set thickness e₀ in the second depositing step, and removing the mold.

The present invention relates to the field of spectral filtering, especially spectral filtering intended for imaging applications.

It relates to a process for producing a spectral filter having multiple applications. Mention may especially be made of CMOS image sensors, liquid-crystal display devices or even light-emitting diodes.

A spectral filter or even a color filter allows light to be filtered by wavelength, so as to provide information on the intensity of the light at certain wavelengths.

A number of color filters may be associated in order, for example, to form RGB (red-green-blue) filters, which allow information to be obtained on the intensity of these three colors.

Thus, a semiconductor imaging device may comprise, on a stack of semiconductor layers, a network of color filters. The latter take the form of resist blocks containing pigment particles. This network is covered with a lens.

When light passes through this lens, each filter transmits light of one color, for example the color green, and this green light is collected by a corresponding receiving element provided in the stack of layers.

Barrier layers are provided in the stack, between the colored blocks and the corresponding receiving elements, in order to isolate the receiving elements from one another.

A device of this type has many drawbacks.

Firstly, it is obtained by a process involving many photolithography steps.

Moreover, on account of the distance between the barrier layers and the receiving elements, the optical isolation between the latter may be poor. Thus, light may be received by the wrong receiving element, especially when it penetrates into the device obliquely. This degrades the color separating function, the resolution and the wavelength sensitivity of the device.

Document U.S. Pat. No. 7,759,679 thus proposes a semiconductor imaging device in which the color filters are each formed from a stack of dielectric layers.

Thus the color filters may have a smaller thickness than that of the pigment-containing resist blocks. This allows the distance between the receiving elements and the barrier layers to be decreased, allowing the color separating function of the device to be improved.

Each color filter requires a specific stack structure that may comprise a large number of dielectric layers arranged in alternation.

Thus, producing this type of device still requires many steps.

It has also been envisioned to use nanostructured dielectric layers for this type of application. In this regard the reader may refer to the article by V. Lousse et al. “Angular and polarization properties of a photonic crystal slab mirror”, Optics Express, Vol. 12 (8), pp 1575, 2004.

However, these dielectric layers turn out to be very sensitive to the angle of incidence of the light.

A metal filter for image-sensing applications in the visible has also been proposed. For this purpose reference may be made to the article by P. B. Cartrysse et al. “One-mode model for patterned metal layers inside integrated color pixels” Optics Letters, Vol. 29, No. 9, pp 974-976, 2004.

In this case, the filtering is achieved using a high-pass filter to block guided modes in a one-dimensional grating. However, the filtering obtained is highly dependent on the polarization of the light.

Other metal/dielectric filters are known, which filters comprise at least one dielectric layer arranged between two thin metal films in order to form a Fabry-Perot cavity.

Thus, document U.S. Pat. No. 6,031,653 describes a filter comprising two transparent plates (for example made of glass) spaced apart from each other to form a cavity. The two opposed surfaces of the transparent plates are covered with thin metal films. These two metal films and the central cavity form a Fabry-Perot cavity. The transmission of the filter is adjusted by adjusting the thickness of the cavity.

Thus, in operation, a portion of the incident light corresponding to the wavelength of the filter is transmitted through the latter in the form of a colored beam, whereas the rest of the incident light is reflected.

Generally, the thickness of the dielectric layer sets the transmitted central wavelength whereas the thickness of the metal layers allows the transmitted spectral width to be adjusted.

Moreover, using a number of Fabry-Perot cavities allows the spectral profile transmitted by the filter to be modified.

A filter of this type is produced using conventional semiconductor fabrication techniques.

Thus, to obtain an RGB filter it is necessary to form at least one dielectric cavity the thickness of which has to have three different values.

This requires a masking step and then an etching step for each dielectric cavity produced.

Once the three-color filter has been produced, it is then recommended to planarize it before continuing with other steps, such as the formation of microlenses on the filter. The planarization step requires an additional layer to be added, thereby increasing the thickness of the stack. This increases the passage of photons from a lens into a neighboring pixel, and therefore decreases the resolution of the filter.

Generally, the number of masking and etching steps increases with the desired number of cavities of different thicknesses. Typically, four photolithography steps are necessary to obtain a three-color filter.

Document U.S. Pat. No. 6,031,653 describes a process allowing three zones of different thicknesses to be obtained in a photosensitive resist layer using one etching step. To do this, a mask comprising a number of gray levels is used. However, the materials obtained are not physically and chemically stable. Moreover, on account of the process used, the refractive indices will not be uniform from one zone to another, or even inside a given zone. This is a major drawback for a filter.

Fabry-Perot filters have the advantage of not requiring an infrared filter, in contrast to imaging sensors in the visible domain, because the metal layers allow infrared waves to be reflected.

Moreover, they are relatively thin, their thickness generally being comprised between 350 and 450 nm, whereas the pigment-containing resist blocks are typically 1 μm in thickness.

This relatively small thickness is favorable to color separation and resolution.

Lastly, these filters allow a spectral response that can be adjusted, by adjusting the thickness of the dielectric layer, to be obtained.

However, Fabry-Perot filters have drawbacks.

Firstly, they must be produced on substrates compatible with the field of microelectronics or microelectromechanics. This constraint essentially means that substrates made of glass or silicon and having a flat surface must be used.

Moreover, fabrication of these Fabry-Perot filters requires a large number of steps (lithography, etching, deposition and cleaning) to be carried out. Certain of them require expensive tools. This is especially the case for lithography and etching.

This leads to a relatively high fabrication cost.

The object of the invention is to remedy these drawbacks by providing a process for producing a spectral filter, this process being simpler to implement and resulting in a filter having the same advantages as Fabry-Perot filters.

Thus, the invention relates to a process for producing an electromagnetic radiation filter comprising at least two color filters, each formed from a stack on a stiff substrate of at least one dielectric layer and of metal layers in alternation, in order to transmit at least two colors, said process comprising the following steps:

(a) depositing on said substrate a first metal layer;

(b) depositing on said first metal layer a first mechanically deformable dielectric layer having a set thickness;

(c) depositing on said first dielectric layer a second metal layer;

(d) imprinting the stack obtained with a mold applied to the entire surface of the stack and allowing material to be simultaneously moved in at least two zones of the stack and thus, in said at least two zones, two different thicknesses of said first dielectric layer to be obtained, these two thicknesses being different from the thickness of this dielectric layer in step (b); and

(e) removing the mold.

In one embodiment, this process comprises, before step (d), two complementary steps consisting in:

(c₁) depositing on said second metal layer, a second mechanically deformable dielectric layer having a set thickness; and

(c₂) depositing on said second dielectric layer, a third metal layer,

the imprinting step (d) also allowing, in said at least two zones of the stack, two different thicknesses of said second dielectric layer to be obtained, these two thicknesses being different from that of the second dielectric layer in step (c₁).

In another embodiment, the process according to the invention comprises, before step (b), a complementary step (b₀) consisting in depositing, on said first metal layer, a mechanically nondeformable dielectric layer.

In another embodiment, the process according to the invention comprises, before step (c₁), a complementary step (c₀) consisting in depositing, on said second metal layer, a mechanically nondeformable dielectric layer.

Preferably, the mold has a surface, intended to make contact with the entire surface of the stack in step (d), which comprises at least two zones designed to exert different pressures on the stack.

Thus, said at least two zones are advantageously offset in a direction perpendicular to said surface, the mold being subjected to a uniform pressure.

Preferably, the mechanically deformable dielectric is deformable at low temperatures.

Also preferably, the mechanically deformable dielectric is a thermoplastic resist.

The invention will be better understood and other aims, advantages and features thereof will become more clearly apparent on reading the following description, which is given with reference to the appended drawings in which:

FIG. 1 illustrates the first steps of the process according to the invention, for obtaining an example filter;

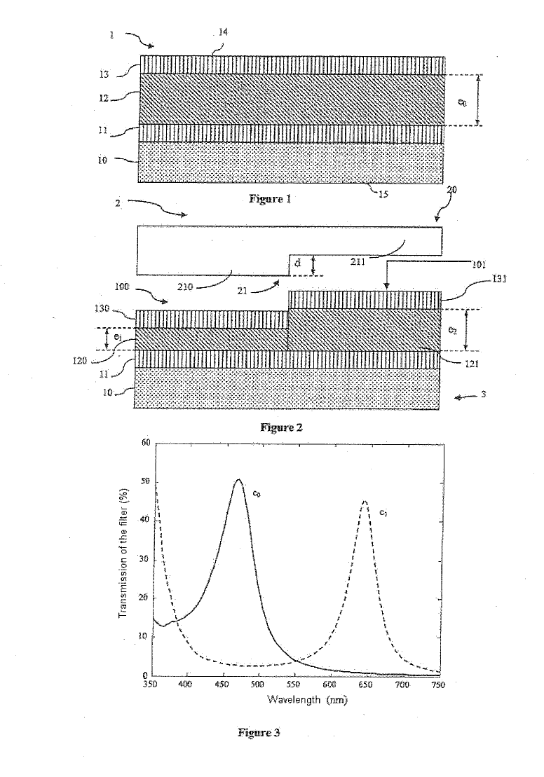

FIG. 2 illustrates the imprinting step of the process according to the invention, for this example filter;

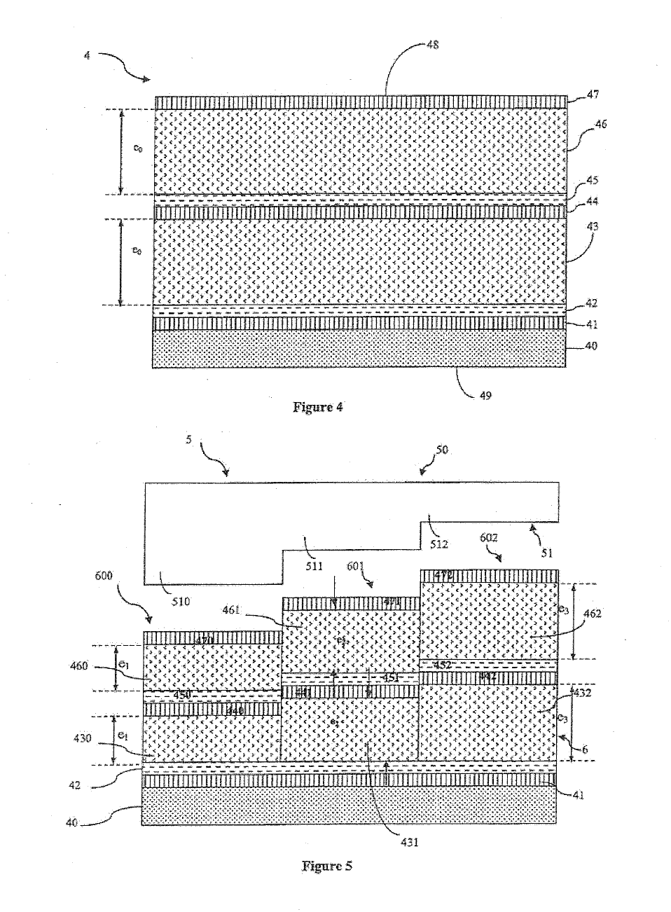

FIG. 3 contains two curves illustrating the transmission of a two-color filter such as that illustrated in FIG. 2, as a function of wavelength;

FIG. 4 illustrates the first steps of the process according to the invention, for obtaining another example filter;

FIG. 5 shows a cross-sectional view of another example of a filter obtained by the process according to the invention, and comprising three color filters;

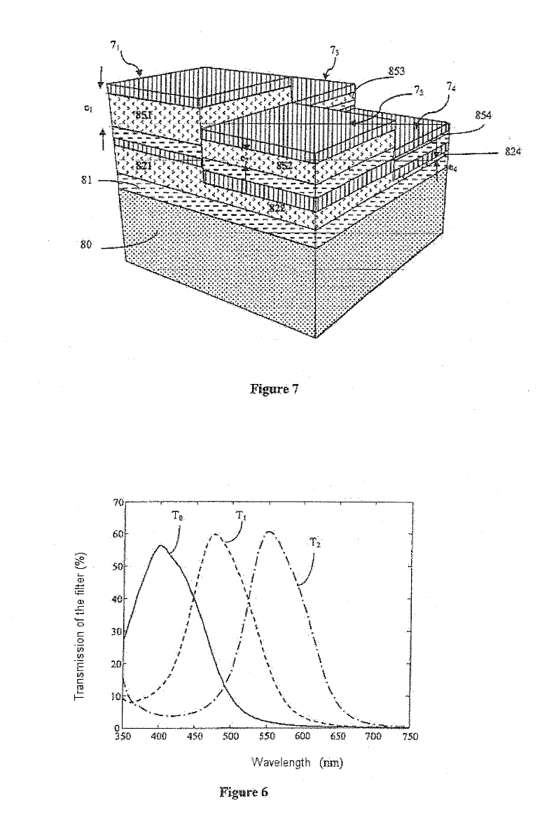

FIG. 6 contains three curves illustrating the transmission of a filter of the type illustrated in FIG. 5, as a function of wavelength; and

FIG. 7 is a perspective view of another example filter obtained with the process according to the invention.

The first steps of the process according to the invention will now be described with reference to FIG. 1.

A first metal layer 11 is deposited on a substrate 10.

The substrate may be made of glass, silicon or a relatively nondeformable stack.

Generally, the substrate 10 is stiff or its side 15 opposite the first metal layer 11 is placed on a stiff counter support.

Moreover, in contrast to Fabry-Perot filters, the substrate does not necessarily have a flat surface.

A dielectric layer 12 that has a thickness e₀ is deposited on this first metal layer 11.

This dielectric has the property of being mechanically deformable. The expression “mechanically deformable material” is here understood to mean a material that can be deformed by applying pressure, this deformation being permanent. The force that must be applied to this material in order to deform it depends on the temperature of the material.

By way of example, the dielectric used will possibly be a chemically stable resist, insofar as the dielectric layer makes contact with the metal.

This is especially the case for thermoplastic resists.

Materials other than resists, such as in particular sol-gels, may also be envisioned.

A second metal layer 13 is deposited on this dielectric layer 12. The stack 1 illustrated in FIG. 1 is then obtained.

As this figure illustrates, the thickness of the various layers 11 to 13 is identical throughout the stack.

Thus, the stack 1 illustrated in FIG. 1 may form a one-color filter. The thickness e₀ of the layer 12 sets the transmitted central wavelength, as for a Fabry-Perot filter.

Here, the stack 1 is shown in cross section. It is thus bounded by a top surface 14 and an opposite bottom surface 15, which surfaces may for example have a square shape.

FIG. 2 illustrates, also in cross section, a mold 2.

This mold 2 has a generally flat shape and is bounded by a top surface 20 and a bottom surface 21.

This surface 21 is intended to make contact with the top surface 14 of the stack 1. It is substantially the same size as the surface 14 of the stack.

As illustrated in FIG. 2, it comprises two zones 210 and 211 that are offset in a direction perpendicular to the surface 21. In practice, these two zones 210 and 211 are substantially flat and the zone 210 protrudes relative to the zone 211. The offset between the two zones 210 and 211 is referenced d in FIG. 2. In the example illustrated, these two zones have an identical area.

The value of the offset d is smaller than the total thickness of the stack 1, in order to prevent a layer other than the second metal layer from breaking.

Next, the mold 2 is applied to the top surface 14 of the stack 1 (the mold makes contact with all of this surface) then pressure is applied to the mold. This pressure must be sufficiently high to allow the dielectric to be deformed plastically.

On account of the shape of the mold, its part 210 exerts, on the stack, a larger pressure than its other part 211. Thus, the two parts 210 and 211 of the mold simultaneously exert a set pressure and simultaneously move material within the dielectric layer. Thus, the stack 1, due to the pressure exerted by the mold 2, is modified and contains two adjacent altered parts 100 and 101.

The shape of the mold could be modified in order for the two parts 100 and 101 not to be adjacent.

In the part 100 of the stack 1 facing the zone 210 of the mold 2, the dielectric layer 12 is pressed more than in the part 101 of the stack facing the zone 211 of the mold.

Thus, in the part 100, the dielectric layer 12 loses a volume of deformable material, which volume is transferred to the part 101 subjected to a smaller pressure.

Therefore, the action of the mold 2 allows, in the stack, a part 100 having a dielectric layer 120 of thickness e₁, and a part 101 having a dielectric layer 121 of thickness e₂, to be obtained, the thicknesses e₁ and e₂ being different. Each of the parts has a polygonal (rectangular for example) shape.

It should be noted that, by virtue of the presence of a stiff substrate or stiff counter support, mechanical deformation of the stack 1 opposite the top surface 14 is minimized. Thus, the flow or transfer of deformable dielectric material may be controlled and set with precision. Therefore, the thicknesses e₁ and e₂ of the dielectric layers 120 and 121 are perfectly controlled, as is the wavelength transmitted by each of the parts of the stack.

The mold is removed when the dielectric layers 120 and 121 have the desired thickness. The dielectric material is deformed irreversibly and the thicknesses e₁ and e₂ are set.

The filter 3 obtained after imprinting of the stack 1 with the mold 2 allows two different colors to be filtered since the thicknesses e₁ and e₂ are different.

Generally, the text “Nanotechnology”, ISTE-Wiley 2011 by Stefan Landis describes the imprinting technique.

However, the thickness of the first metal layer 11 is identical in the stack 1 and in the filter 3. Likewise, the thickness of the metal layers 130 and 131 of the filter 3 is identical to that of the second metal layer 13.

For the sake of simplicity, FIG. 2 illustrates a metal layer 13 that has been broken and that forms two layers 130 and 131. In practice, the layer 13 may only be deformed under the effect of the pressure exerted on the mold. Since the yield strength of a metal is much higher than that of a resist, it is the dielectric layer that sees its volume change and not the metal layer.

Of course, the value of the pressure exerted on the mold in order to deform the stack 1 depends on the dielectric material of the layer 12, on the temperature of the stack, and on the thickness of the metal layer 13.

Generally, the force to be exerted on the stack 1 will be smaller if its temperature is higher than room temperature. However, the temperature chosen must be below that at which the dielectric material melts. Specifically, at such a temperature, the stack would be deformed but its constituent materials would mix during this deformation, and a filter such as illustrated in FIG. 3 would not be obtained.

FIG. 2 illustrates that the thicknesses e₁, of the dielectric layer 120, and e₂, of the dielectric layer 121, are both different from the thickness e₀ of the dielectric layer 12 initially provided in the stack 1.

Insofar as the thicknesses e₁ and e₂ set the central wavelength transmitted by the two parts of the filter 3, it is now worthwhile explaining how they are chosen.

Generally, the filter is dimensioned using an electromagnetic calculation program. Mention may for example be made of the transfer matrix formalism of Abeles (“Principles of optics” by Born and Wolf, 1964) or of the formalism of the modal Fourier expansion method, or of rigorous coupled-wave analysis (RCWA) (J. Optical Society of America A 12/5, 1068-1076, May 1995).

This calculation program allows the structural parameters of the metal/dielectric stacks to be determined per pixel or even for each filter dedicated to a particular color.

This calculation involves the thicknesses of the metal and dielectric layers, their indices, the spectrum of the incident light and the angular distribution of the incident light.

Generally, this calculation will be used to obtain effective spectral filtering. Thus, in the context of a three-color RGB filter, the various parameters will for example be chosen to obtain filtering with a minimum amount of noise, or even a maximum light intensity.

In the case of a Fabry-Perot filter, the thickness of the dielectric layer will be set in the following way.

The central wavelength X of a filter, comprising a dielectric layer, is given approximately by:

$$λ = \frac{2. e . n . cos θ}{m - \frac{{ϕ}_{1} + {ϕ}_{2}}{2 π}}$$

where:
e is the thickness of the cavity, i.e. the thickness of the layer of dielectric material;
m is the order of the cavity or the order of the Fabry-Perot mode;
n is the effective index of the cavity, i.e. the refractive index of the layer 120 or 121;
φ₁ and φ₂ are the phase shifts on reflection from the metal layers or mirrors; and
θ is the angle of incidence of the incident light on the filter (measured from perpendicular to the surface of the filter).

The order of the cavity m is a positive integer between 1 and 10. It is generally chosen to be equal to 1.

The phase shifts on reflection φ₁ and φ₂ depend on the nature of the materials and on the incident wavelength considered.

Thus, once the order of the cavity has been chosen and the angle of incidence of the light, the index of the cavity and the phase shifts are known, equation (E) allows an approximate thickness e to be determined so that the cavity is centered on a given wavelength.

Once the filtering function has been calculated for each filter and each wavelength, the thickness e of the cavity (and therefore of the dielectric layer) and the thickness of the metal layers are adjusted depending on the required performance. Thus, depending on the application, a high efficiency and maximum transmission or even a maximum signal-to-noise ratio will be sought.

The thickness e may also be adjusted in a more empirical way. Thus, another method consists in calculating, for a number of thicknesses e, the response of the filter, and in choosing the thickness e corresponding to the filter the response of which has a reference peak positioned in accordance with the specifications.

Thus, if the filter 3 illustrated in FIG. 2 is referred to, the thickness e₁ of the dielectric layer 120, the thickness e₂ of the dielectric layer 121, and the thickness of the metal layers 11, 130 and 131 are determined by calculation.

This makes it possible to determine the structure of the stack 1 that will be subjected to an imprinting step with the mold 2.

Specifically, volume may be considered to be conserved locally in the dielectric layer. In other words, the overall amount of material is conserved. Thus, if the two zones 210 and 211 of the mold 2 have identical areas, the thickness e₀ will be equal to (e₁+e₂)/2. In the case where the two zones 210 and 211 have different areas, the thickness e₀ will be equal to (S₁·e₁+S₂·e₂)/(S₁+S₂) where S₁ is the area of the zone 210 and S₂ is the area of the zone 211, the area of the stack being equal to (S₁+S₂).

Moreover, once the thicknesses e₁ and e₂ of each zone 210, 211 are known, the mold is dimensioned so that the offset d is equal to |e₁−e₂|.

The above will be illustrated with a filter of the same type as the filter 3 illustrated in FIG. 2, and designed to separate the colors red and blue.

This two-color filter is obtained from a stack of the same type as that illustrated in FIG. 1.

In this example, the substrate is made of glass, the first and second metal layers 11 and 13 are made of silver and are 30 nm in thickness. Lastly, the thickness e₀ of the layer 13 of dielectric material is 120 nm.

This material may be a thermoplastic resist that passes from the solid state to a viscous or elastoviscous state when its temperature is raised above its glass transition temperature. This conversion is reversible.

Next, the stack obtained is subjected to an imprinting step with the mold 2 illustrated in FIG. 2, thereby allowing a filter to be obtained in which the metal layers 11, 130 and 131 are still 30 nm in thickness. In contrast, the thickness e₁ of the dielectric layer 120 is 90 nm and the thickness e₂ of the dielectric layer 121 is 150 nm.

Of course, during the imprinting step the force applied to the mold and the time for which the force is applied are chosen so as to deform the stack no more once the thickness e₁ is obtained for the dielectric layer 120. By way of example, a pressure of about 60 bars will be applied for three hours at a temperature of 20° C., this temperature being below the glass transition temperature of the material of the layer 12.

When the mold 2 is removed, a filter such as illustrated in FIG. 2 is obtained. Insofar as the dielectric material used deforms irreversibly, the structure of the filter is preserved, with the desired thicknesses.

It should be noted that in practice, in contrast to what is shown in FIG. 2, the parts 100 and 101 are not separated by a right surface. In contrast, the two parts are connected by a deformation zone that is more continuous.

Reference is now made to FIG. 3, which illustrates the response of the filter 3 in the example considered.

Thus, the curve C₀ illustrates the transmission of the part 100 of the filter 3, whereas the curve C₁ illustrates the transmission of the part 101 of the filter 3, in both cases as a function of wavelength. Each of these curves has a peak shape.

The part 100 of the filter 3 is centered on a wavelength of 460 nm. This is a filter for the color blue.

The part 101 of the filter 3 is centered on a wavelength of 650 nm. This is a filter for the color red.

The above description shows that the process according to the invention allows at least two filters of different colors to be obtained from the same stack, without masking, etching or even cleaning steps being required.

This process is therefore much simpler than prior-art processes though it still allows filters having the same performance as those obtained using known processes, especially that described in document U.S. Pat. No. 7,759,659, to be obtained.

Now, another embodiment of a filter obtained with the process according to the invention will be described with reference to FIGS. 4 and 5.

FIG. 4 illustrates, in cross section, the stack 4 from which the filter will be obtained. It is bounded by a top surface 48 and a bottom surface 49.

This stack is obtained by depositing a first metal layer 41 on a substrate 40, on the side opposite the bottom surface 49. The surface of the substrate is not necessarily flat.

As indicated with reference to FIG. 1, the substrate 40 is stiff or placed against a stiff counter support.

A first dielectric layer 42 is deposited on this metal layer 41, this dielectric not being mechanically deformable. This may especially be a mineral dielectric.

A first layer 43 of a dielectric that is mechanically deformable is deposited on this layer 42.

In practice, this means that, in the pressure range used, the yield strength of the material forming the layer 42 is higher than that of the material forming the layers deposited on the layer 42.

Next, a second metal layer 44, a second layer 45 of mechanically nondeformable dielectric, a second layer 46 of mechanically deformable dielectric and lastly a third metal layer 47 are deposited in succession on this layer 43.

When the layers 42 and 45 are thin, the position of the layers 45 and 46 on the one hand, and of the layers 42 and 43 on the other hand, may be swapped.

Moreover, the thickness of the layer 42 may be different from that of the layer 45, and the thicknesses of the layers 43 and 46 may be different, contrary to what is illustrated in this example.

Lastly, the layers 41, 44 and 47 may have different thicknesses.

This allows the maximum transmission of the filter and the shape of the transmission spectrum to be adjusted with greater precision.

However, the thickness of each layer 41, 44 or 47 is uniform throughout the stack.

This contributes to decreasing fabrication cost. However, layers of variable thickness may be envisioned, in order to obtain better adjustment of the filters in wavelength, transmission or peak width.

As illustrated in FIG. 5, an imprinting step is carried out on the stack 4 using the mold 5.

Like the mold 2 illustrated in FIG. 2, the mold 5 has a substantially flat shape, bounded by a top surface 50 and a bottom surface 51.

The bottom surface 51 is intended to make contact with all of the top surface 48 of the stack 4. Here, it comprises three different zones 510, 511 and 512 of identical size.

As for the filter 2 illustrated in FIG. 2, each of these three zones is offset relative to the others in a direction perpendicular to the surface 51.

The mold 5 is therefore applied to the entire surface 48 of the stack 4 and with a pressure chosen beforehand. This pressure is applied simultaneously to the entire surface 48. It causes the metal layers 47 and 44 to break, dielectric material to be simultaneously transferred within the layers 43 and 46, and three different parts 600, 601 and 602, facing each of the zones of the mold 510, 511 and 512, to be created in the stack.

Applying pressure inside the stack 4 causes dielectric to transfer from the part 600 that is subjected to the highest pressure, to the part 602 that is subjected to the lowest pressure.

Thus, in the part 600 of the filter 6, the thickness e₁ of the first and second dielectric layers 430 and 460 is smaller than the thickness e₂ of the first and second dielectric layers 431 and 461 of the part 601 of the filter. Moreover, this thickness e₂ is itself smaller than the thickness e₃ of the first and second dielectric layers 432 and 462 of the third part 602 of the filter 6.

The overall amount of material is conserved. Thus, when the zones 510 to 512 have identical areas, the thickness e₀ will be equal to (e₁₊e₂₊e₃)/3. When the areas of these zones 510 to 512 are different, the thickness e₀ will be equal to (S₁·e₁+S₂·e₂+S₃·e₃)/(S₁+S₂+S₃) where S₁, S₂ and S₃ are the areas of the zone 600, the zone 601 and the zone 602, respectively, the area of the stack being equal to (S₁+S₂+S₃).

In contrast, the thickness of the other layers is not modified in the imprinting step.

The function of the mechanically nondeformable dielectric layers is to allow the thicknesses of the cavities obtained after the pressure has been applied via the mold to be adjusted with greater precision. Specifically, the applied pressure is uniform and the amount of resist before and after the pressure has been applied is the same. These layers therefore make it possible to introduce an adjustment variable.

Each of the parts 600 to 602 is polygonal (and especially rectangular) in shape.

By virtue of the presence of a stiff substrate or stiff counter support, mechanical deformation of the side of the substrate is once more minimized. As indicated with reference to FIGS. 1 and 2, this allows the thicknesses e₁ to e₃ and the wavelength transmitted by each of the parts 600 to 602 to be controlled with precision.

Furthermore, it should be noted that the two dielectric layers 43 and 46 are deformed simultaneously during the application of pressure via the mold 5, thereby contributing to good control of the thicknesses obtained in each layer. Specifically, if the layers were deformed in succession, applying pressure to the second layer 46 would lead to uncontrolled deformation of the first layer 43.

An example of a filter of the same type as that illustrated in FIG. 5, and designed to separate the colors green, red and blue, will now be given.

This three-color filter is obtained from a stack of the same type as that illustrated in FIG. 4.

In this example, the substrate is made of glass and the three metal layers are made of silver. The first metal layer 41 has a thickness of 20 nm, the second layer 44 a thickness of 36 nm, and the third layer 47 a thickness of 12 nm.

The first mechanically nondeformable dielectric layer 42 is made of a thermoplastic or thermosetting resist or a photoresist and has a thickness of 65 nm.

Likewise, the second nondeformable dielectric layer 45 is made of ZnS/SiO₂ and has a thickness of 65 nm.

Lastly, the first and second mechanically deformable dielectric layers 43 and 46 have a thickness e₀ of 30 nm. They may be made of an organic resist or an organometallic material or sol-gel. A sol-gel consists of organic and mineral materials. It may be stabilized under UV or thermally.

The stack obtained is then subjected to an imprinting step with the mold 5 illustrated in FIG. 5, thereby allowing a filter 6 to be obtained in which the thicknesses of the metal layers 41, 440, 441, 442 and 470, 471, 472 are unchanged. The same goes for the thicknesses of the first mechanically nondeformable dielectric layers 42, 450, 451 and 452.

In contrast, the thickness e₁ of the deformable dielectric layers 430 and 460 is 5 nm and the thickness e₃ of the deformable dielectric layers 432 and 462 is 55 nm.

In this particular example, the thickness e₂ of the deformable dielectric layers 431 and 461 is equal to e₀, i.e. to 30 nm.

In the imprinting step, the force applied to the mold and the length of time that this force is applied are chosen so that this step is stopped and the mold removed when the desired thickness e₁ is obtained for the dielectric layers 430 and 460.

By way of example, a pressure of about 60 bars is applied for 3 hours at a temperature of 20° C., this temperature being below the glass transition temperature of the material of the layers 43 or 46.

After the mold has been removed, a filter such as that illustrated in FIG. 5 is obtained. This structure retains the desired thicknesses since the dielectric material of the layers 43 and 46 of the stack is irreversibly deformed.

In the illustrated example, the thicknesses of the layers 460, 430; respectively 461, 431; respectively 462, 432, are equal. The invention is not limited to this example. Depending on the materials used to produce the layers 43 and 46 and/or the heating conditions of the stack, these thicknesses could be different inside a given part of the filter.

Reference is now made to FIG. 6, which illustrates the response of the filter 6 in the example considered.

Thus, the curve T₀ illustrates the transmission of the part 600 of the filter 6, the curve T₁ the transmission of the part 601, and the curve T₂ the transmission of the part 602, in all three cases as a function of wavelength.

Thus, FIG. 6 shows that the part 600 of the filter 6 is centered on a wavelength of 400 nm. This is a filter for the color green.

The part 601 of the filter 6 is centered on a wavelength of 460 nm. This is a filter for the color blue.

Lastly, the part 602 of the filter 6 is centered on a wavelength of 560 nm. This is a filter for the color red.

This embodiment of the process according to the invention shows it is possible to obtain, from a given stack, three different color filters without steps of masking, etching or cleaning being required.

Comparing FIGS. 3 and 6 shows that the filter according to FIG. 2 allows layers forming a peak having a smaller width than that of the curves obtained with the filter according to FIG. 5 to be obtained. Thus, a filter having a single cavity will be chosen when the envisioned application requires a high transmission level and a high resolution. In contrast, a filter comprising at least two cavities will be chosen when the application requires a high signal-to-noise ratio and more straightforward reconstitution of the colors for the image.

Reference is now made to FIG. 7, which illustrates another filter obtained with the process according to the invention.

This filter is a three-color filter composed of four filters or pixels.

The pixel 7₁ is intended to filter a first color, for example the color red, the pixels 7₂ and 7₃ are intended to filter the same color, for example the color green, and the pixel 7₄ is intended to filter another color, for example the color blue.

This filter is obtained from a stack of the same type as that illustrated in FIG. 4, with a substrate 80, a first layer 81 made of a mechanically nondeformable dielectric material, a first layer of mechanically deformable dielectric material, a first metal layer, a second layer of mechanically nondeformable dielectric material, a second layer of mechanically deformable material, and lastly a second metal layer.

In this stack, the surface of which is substantially square, different zones, also square in shape, are delimited. The highest pressure is applied to the zone corresponding to the pixel 7₄. A lower pressure is applied to the zones corresponding to the pixels 7₂ and 7₃, and an even lower pressure is applied to the zone corresponding to the pixel 7₁.

Thus, in the pixels 7₂ and 7₃, the dielectric layers 822, 852 or 853 will have the same thickness e₂.

This thickness e₂ is larger than that e₄ of the dielectric layers 824 and 854 in the pixel 7₄.

This thickness e₂ will in contrast be smaller than the thickness e₁ of the dielectric layers 821 and 851 in the pixel 7₁.

Of course, as explained above, the thickness of the first and second deformable dielectric layers of the initial stack is appropriately chosen so that the thicknesses e₁, e₂ and e₃ of the various pixels allow the color that each pixel is intended to filter to be adjusted.

Moreover, the process according to the invention could also allow filters comprising more than four pixels, or even filters comprising pixels of different geometry, to be obtained.

The process according to the invention may also be used to produce arrays of pixels.

These arrays may especially consist of periodically arranged pixels, for example a repetition of a matrix of four pixels, such as illustrated in FIG. 7. It is then enough for the imprinting mold to also be designed with the same periodicity for the desired array to be obtained after application of the pressure.

It should also be noted that the process according to the invention may be applied to stacks that are not necessarily flat. This therefore allows filters having a curved surface to be produced. To do this, a substrate having a lens shape is for example used, on which substrate the various aforementioned layers are deposited. A mold of suitable shape is then used to produce the various pixels.

The reference signs inserted after the technical features contained in the claims are there merely to make the latter easier to understand and in no way limit their scope.

1. A process for producing an electromagnetic radiation filter comprising at least two color filters, each formed from a stack on a stiff substrate of at least one dielectric layer and of metal layers in alternation, in order to transmit at least two colors, said process comprising the following steps:
(a) depositing on said substrate (10, 40) a first metal layer (11, 41);
(b) depositing on said first metal layer a first mechanically deformable dielectric layer (12, 43) having a set thickness (e₀);
(c) depositing on said first dielectric layer a second metal layer (13, 44);
(d) imprinting the stack (1, 4) obtained with a mold applied to the entire surface (14, 48) of the stack and allowing material to be simultaneously moved in at least two zones (100, 101; 600, 601, 602) of the stack and thus, in said at least two zones, two different thicknesses (e₁, e₂) of said first dielectric layer to be obtained, these two thicknesses being different from the thickness (e₀) of this dielectric layer in step (b); and
(e) removing the mold.

2. The process as claimed in claim 1, comprising, before step (d), two complementary steps consisting in:
(c₁) depositing on said second metal layer, a second mechanically deformable dielectric layer (46) having a set thickness; and
(c₂) depositing on said second dielectric layer, a third metal layer (47),
the imprinting step (d) also allowing, in said at least two zones of the stack, two different thicknesses of said second dielectric layer to be obtained, these two thicknesses being different from that of the second dielectric layer in step (cᵢ).

3. The process as claimed in claim 1, comprising, before step (b), a complementary step (b₀) consisting in depositing, on said first metal layer, a mechanically nondeformable dielectric layer (42).

4. The process as claimed in claim 2, comprising, before step (c₁), a complementary step (c₀) consisting in depositing, on said second metal layer, a mechanically nondeformable dielectric layer (45).

5. The process as claimed in claim 1 4, in which the mold has a surface (21, 51), intended to make contact with the entire surface (14, 48) of the stack in step (d), which comprises at least two zones (210, 211; 510, 511, 512) designed to exert different pressures on the stack.

6. The process as claimed in claim 5, in which said at least two zones of the mold are advantageously offset in a direction perpendicular to said surface (21, 51), the mold being subjected to a uniform pressure.

7. The process as claimed in claim 1, 6in which the mechanically deformable dielectric is deformable at low temperatures.

8. The process as claimed in claim 1, in which the mechanically deformable dielectric is a thermoplastic resist.
